(19) United States
(12) Patent Application Publication
(10) Pub. No.: US 2008/0235454 A1
(43) Pub. Date: Sep. 25, 2008

(54) Method and Apparatus for Repairing a Processor Core During Run Time in a Multi-Processor Data Processing System

(75) Inventors: Michael Conrad Duron, Pflugerville, TX (US); Mark David McLaughlin, Austin, TX (US)

Correspondence Address: MARK P. KAHLER, 8101 VAILVIEW COVE, AUSTIN, TX, 78750, US

(73) Assignee: IBM Corporation, Austin, TX (US)

(21) Appl. No.: 11/689,556

(22) Filed: Mar. 22, 2007

(51) Int. Cl. G06F 12/00

(52) U.S. Cl. 711/128

(57) ABSTRACT

A data processing system includes multiple processors each having multiple processor cores. A core checkstop from a particular processor core indicates that a memory array associated with the particular core exhibits an error. In response to the core checkstop, the system migrates the workload of the particular processor core to another processor core. The system also removes the particular processor core from the current configuration of the system. In response to the core checkstop and error, the system initializes the particular processor core if the error is in a processor memory array associated with the particular core. The system then attempts correction of the error with array built-in self test (ABIST) circuitry. If the ABIST succeeds in correcting the error, the initialization of the particular processor core completes and the system returns the particular processor core to the current processor configuration. However, if the ABIST does not succeed in correcting the error, then the system removes the portion of the processor memory array including the error from future use.

### TECHNICAL FIELD OF THE INVENTION

The disclosures herein relate generally to data processing systems, and more particularly, to data processing systems that employ processors with multiple processor cores.

### BACKGROUND

Modern data processing systems often employ arrays of processors to form processor systems that achieve high performance operation. These processor systems may include advanced features to enhance system availability despite the occurrence of an error in a system component. One such feature is the “persistent deallocation” of system components such as processors and memory. Persistent deallocation provides a mechanism for marking system components as unavailable after they experience unrecoverable errors. This feature prevents such marked components from inclusion in the configuration of the processor system or data processing system at boot time or initialization. For example, a service processor in the processor system may include firmware that marks components as unavailable if 1) the component failed a test at system boot time, 2) the component experienced an unrecoverable error at run time, or 3) the component exceeded a threshold of recoverable errors during run time.

Some contemporary processor systems employ “dynamic deallocation” of system components such as processors and memory. This feature effectively removes a component from use during run time if the component exceeds a predetermined threshold of recoverable errors.

High performance multi-processor data processing systems may employ processors that each include internal memory arrays such as L1 and L2 cache memories. If one of these cache memory arrays exhibits a correctable error, error correction is often possible. For example, when the processor system detects an error in a particular cache memory array, an array built-in self test (ABIST) may detect an error that is repairable. Upon detection of the error, the system may set a flag bit to instruct ABIST to run on the next boot and attempt to correct the error. Unfortunately, this methodology does not handle uncorrectable errors and typically requires rebooting of the processor system to launch the ABIST error correction attempt.

Other approaches are also available to attempt correction of errors in internal memory arrays such as caches. For example, if a load operation from the cache fails and causes a cache error, the processor system may retry the load operation several times. If retrying the load operation still fails, then the system may attempt the same load operation from the next level of cache memory. In another approach, the processor system may include software that assists in recovery from cache parity errors. For example, after detecting a cache parity error, the software flushes the cache and synchronizes the processor. After the flushing and synchronization operations, the processor system performs a retry of the cache load in an attempt to correct the cache error. While this method may work, flushing the cache and re-synchronization consume valuable processor system time and do not actually repair the cache.

What is needed is an apparatus and methodology for processor system repair that addresses the problems above.

### SUMMARY

Accordingly, in one embodiment, a method is disclosed for repairing a data processing system during run time of the system. The method includes processing information during run time, by a particular processor core of the data processing system, to handle a workload assigned to the particular processor core. The data processing system includes a plurality of processors that include multiple processor cores of which the particular processor core is one processor core. The method also includes receiving, by a core error handler, a core checkstop from the particular processor core, the core checkstop indicating an error that is uncorrectable at run time of the particular processor core. The method further includes transferring, by the core error handler in response to the core checkstop, the workload of the particular processor core to another processor core of the system and moving the particular processor core off-line. The method still further includes initializing, by a service processor, the particular processor core if a processor memory array of the particular processor core exhibits an error that is not correctable at run time, thus initiating a boot time for the particular processor core. The method also includes attempting, by the service processor, to correct the error at boot time of the particular processor core. The method further includes moving, by the service processor, the particular processor core back on-line if the attempting step is successful in correcting the error so that the particular processor core may again process information at run time.

In another embodiment, a multi-processor data processing system is disclosed that includes a plurality of processors, each processor including a plurality of processor cores. The system includes a service processor, coupled to the plurality of processor cores, to handle system checkstops from the plurality of processors. The system also includes a core error handler, coupled to the plurality of processor cores, to handle core checkstops from the plurality of processor cores. The core error handler receives a core checkstop from a particular processor core. The core checkstop indicates an error that is uncorrectable at run time of the particular processor core. The core error handler transfers the workload of the particular processor core to another processor core of the system and moves the particular processor core off-line in response to the core checkstop. The service processor initializes the particular processor core if a processor memory array of the particular processor core exhibits an error that is not correctable at run time, thus initiating a boot time for the particular processor core. The service processor also attempts to correct the error at boot time of the particular processor core. The service processor then moves the particular processor core back on-line if the attempt to correct the error at boot time is successful so that the particular processor core may again process information at run time.

### BRIEF DESCRIPTION OF THE DRAWINGS

The appended drawings illustrate only exemplary embodiments of the invention and therefore do not limit its scope because the inventive concepts lend themselves to other equally effective embodiments.

FIG. 1 shows a block diagram of the disclosed multi-processor data processing system.

FIG. 2 shows a block diagram of a representative multi-core processor that the disclosed data processing system employs.

FIG. 3 show an alternative block diagram of the disclosed data processing system.

FIG. 4 is a flowchart that shows process flow in the error correction methodology that the disclosed data processing system employs when the system encounters a processor core checkstop.

FIG. 5 is a flowchart that shows process flow in the error correction methodology that the disclosed data processing system employs when the system encounters a system checkstop.

### DETAILED DESCRIPTION

The terms processor node “hot plugging” or processor node “concurrent maintenance” describe the ability to add or remove a processor node from a fully functional data processing system without disrupting the operating system or software that execute on other processor nodes of the system. A processor node includes one or more processors, memory and I/O devices that interconnect with one another via a common fabric. In one version of the Power6 processor architecture, a user may add up to 8 processor nodes to a data processing system in a hot-plug or concurrent maintenance operation. Thus, the ability to hot-plug allows a user to service or upgrade a system without costly down time that would otherwise result from system shutdowns and restarts. (Power6 is a trademark of the IBM Corporation.)

Some existing processor node hot plugging implementations follow three high level steps. First, prior to changing the data processing system configuration by adding or removing a processor node, the data processing system temporarily disables communication links among all nodes of the system. Second, the data processing system switches old configuration settings that describe the system configuration prior to addition or removal of a processor node to new configuration settings that describe the system configuration after addition or removal of a processor node. Third, the data processing system initializes the communication links to re-enable communication flow among all the nodes in the system. The above three steps execute in a very short amount of time because the software that runs on the system would otherwise hang if the communication paths among processor nodes are not available for transmission of data for a significant amount of time.

When a data processing system performs a concurrent maintenance operation to add or remove a processor node including multiple processors, it is possible that the data processing system may experience a failed node. When such a failed node problem occurs, it is important that the system recover from this problem. One methodology for automatically recovering from such a failed node condition is taught in the U.S. Patent Application 2006/0187818 A1, entitled “Method and Apparatus For Automatic Recovery From A Failed Node Concurrent Maintenance Operation”, filed Feb. 9, 2005, the disclosure of which is incorporated herein by reference in its entirety and which is assigned to the same Assignee as the subject application.

Processor sparing is one method to transfer work from a processor that generates a checkstop to a spare processor. A computer system may include multiple processing units wherein at least one of the units is a spare. The processor sparing method provides a mechanism for transferring the micro-architected state of a checkstopped processor to a spare processor. Processor sparing and processor checkstops are described in U.S. Pat. No. 6,115,829 entitled “Computer System With Transparent Processor Sparing”, and U.S. Pat. No. 6,289,112 entitled “Transparent Processor Sparing” the disclosures of which are both incorporated herein by reference in their entirety and which are assigned to the same Assignee as the subject application.

Multi-processor system may employ a checkstop hierarchy that includes system checkstops, book checkstops and chip checkstops. In such an approach, the multiprocessor system may include multiple books wherein each book includes multiple processors, each processor residing on a respective chip. It the system generates a system checkstop, then the entire system halts normal information processing activities while the system attempts correction. If a particular book of processors generates a book checkstop, then that book of processors halts normal information processing activities while the system attempts correction. If a particular processor or processor chip generates a processor chip checkstop, then that processor chip halts normal information processing activities while the system attempts correction. System checkstops, book checkstops and processor chip checkstops are described in “Run-Control Migration From Single Book To Multibooks” by Webel, et al., IBM JRD, Vol. 48, No. 3/4 May/July 2004, which is incorporated herein by reference in its entirety.

Multi-processor systems may employ processors that each include multiple cores. If one core of a dual core processor in a multi-processor system exhibits a hard logic error, then the processor containing the core with the error generates a checkstop. The system then transfers the workload of both cores to spare cores elsewhere in the multi-processor system. Such an arrangement is described in “Reliability, Availability, And Serviceability (RAS) of the IBM eServer z990, by Fair, et al., IBM JRD Vol. 48, No. 3/4 May/July 2004, which is incorporated herein by reference in its entirety.

The Power6 processor architecture includes the ability to conduct concurrent maintenance or processor sparing on a “per core” basis. Each core in a processor of a Power6 multi-processor system generates a respective “core checkstop”, namely a “local checkstop” if a memory array that associates with that particular core exhibits an error. Internal core errors, interface parity errors and logic errors may also result in a core checkstop. Unlike a system checkstop, that typically involves taking the whole system down when a system checkstop occurs, a core checkstop from a particular core may result in taking the particular core off-line without affecting processing in other cores of the system. In other words, if a processor core exhibits an error or errors that cause such as “core checkstop”, the system may effectively disconnect that processor core while allowing the remaining cores to continue operating during their run time. A core checkstop halts processing in the respective core and instructs the respective core and associated circuitry to save or freeze their state.

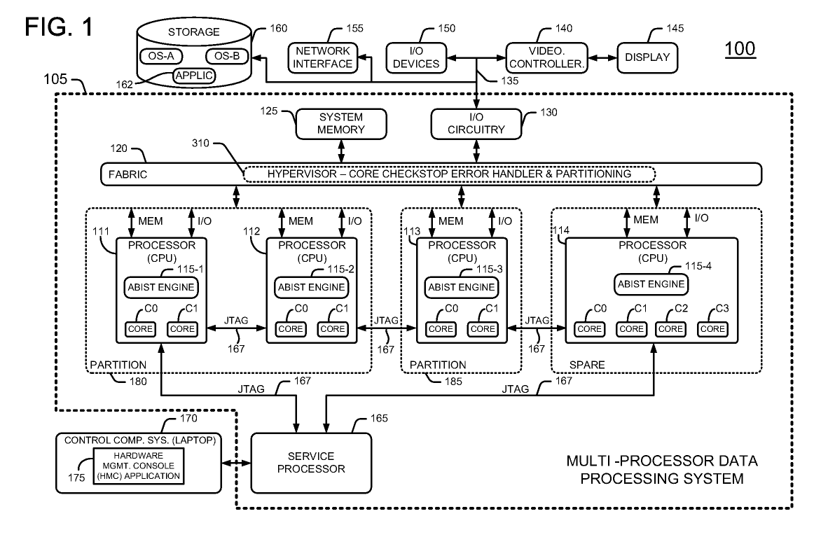

FIG. 1 shows a block diagram of an information handling system (IHS) 100 that includes a multi-processor data processing system 105 with a core checkstop capability. Each processor includes multiple processor cores to enhance performance. When an error occurs in a memory array of a particular processor core, system 105 generates a core checkstop specific to that particular core. In this description, the terms “correctable error” and “uncorrectable error” (or UE) refer to error correctability at run time and error uncorrectability at run time, respectively. Data processing system 105 includes multi-core processors (CPUs) 111, 112, 113 and 114 of which processor 111 is representative. Representative processor 111 includes processor cores C0 and C1 as do remaining processors 112, 113 and 114. While processors 111, 112 and 113 include 2 cores in this particular example, processor 114 includes 4 cores, namely cores C0, C1, C2 and C3. Other embodiments of the disclosed system may employ processors that include more cores than shown in this particular example. Still other embodiments of the disclosed system may employ more or fewer processors than shown in this example. Processor's 111, 112, 113 and 114 include respective ABIST engines 115-1, 115-2, 115-3 and 115-4. In one embodiment processors 111, 112, 113 and 114 include respective semiconductor chips or dies wherein each chip or die includes multiple processor cores. While for illustration purposes FIG. 1 shows an ABIST engine in each processor, in actual practice each processor core may include a respective ABIST engine in that core.

Each of processors 111, 112, 113 and 114 includes a memory bus, MEM, and an input/output bus, I/O. System 105 includes a connective fabric 120 that couples the memory busses, MEM, and the I/O buses, I/O, of processors 111, 112, 113 and 114 to a shared system memory 125 and I/O circuitry 130. Fabric 120 provides communication links among processors 111-114 as well as system memory 125 and I/O circuitry 130. A bus 135 couples to I/O circuitry 130 to allow the coupling of other components to system 105. For example, a video controller 140 couples display 145 to bus 135 to display information to the user. I/O devices 150, such as a keyboard and a mouse pointing device, couple to bus 135. A network interface 155 couples to bus 135 to enable system 105 to connect by wire or wirelessly to a network and other information handling systems. Nonvolatile storage 160, such as a hard disk drive, CD drive, DVD drive, media drive or other nonvolatile storage couples to bus 135 to provide system 105 with permanent storage of information. One or more operating systems, OS-A and OS-B, load from storage 160 to memory 125 to govern the operation of system 105. Storage 160 may store multiple software applications 162 (APPLIC) for execution by system 105.

A service processor 165 couples to a JTAG bus 167 to control system activities such as error handling and system initialization or booting as described in more detail below. JTAG bus 167 loops from service processor 165 through processors 111, 112, 113 and 114 so that service processor 165 may communicate with the cores thereof. In one embodiment, a control computer system 170 such as a laptop, notebook, desktop or other form factor computer system couples to service processor 165. A hardware management console (HMC) application 175 executes in control computer system 170 to provide an interface that allows a user to power on and power off system 105. HMC application 175 also allows the user to set up and run partitions in system 105. In one embodiment, a partition corresponds to an instance of an operating system, namely one operating system per partition. In the particular embodiment shown in FIG. 1, HMC 175 configures processors 111, 112 and 113 into two partitions. More particularly, HMC 175 configures processors 111 and 112 into partition 180 on which operating system OS-A executes. HMC 175 also configures processor 113 into another partition 185 on which operating system OS-B executes, as shown. In one embodiment, operating system OS-A may be an AIX operating system and operating system OS-B may be a Linux operating system, although other operating systems are usable as well. Processor 114 remains a spare resource that HMC 175 may configure in a partition and use at a later time.

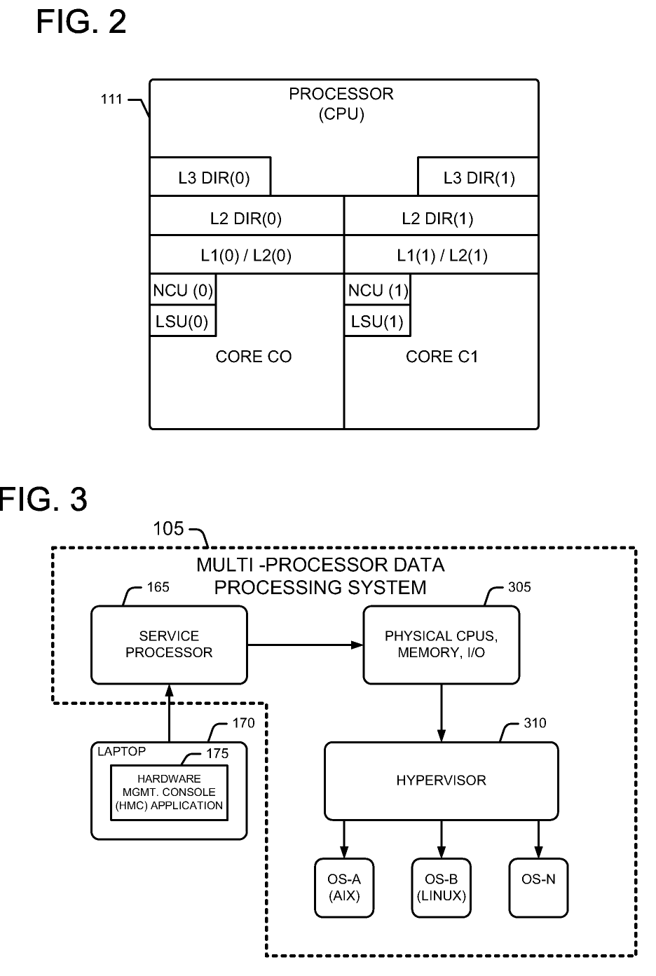

FIG. 2 depicts a representative processor (CPU) 111 of system 105. Processor 111 is a multi-core processor that includes 2 cores, namely cores C0 and C1. Cores C0 and C1 respectively include non cacheable units NCU(0) and NCU(1). NCU (0) and NCU(1) handle memory mapped I/O instructions such as cache-inhibited load and store instructions. Cores C0 and C1 also respectively include load store units LSU(0) and LSU(1). Processor 111 includes L1 and L2 cache memory arrays L1(0) and L2(0) that associate with and supply information to core C0. Processor 111 also includes L1 and L2 cache memory arrays L1(1) and L2(1) that associate with and supply information to core C1. Processor 111 further includes L2 and L3 cache directories, L2 DIR(0) and L3 DIR(0) that associate with core C0. Processor 111 also includes L2 and L3 cache directories, L2 DIR(1) and L3 DIR(1) that associate with core C1. These cache directories hold tags that keep track of the state of the data in the respective caches, such as modified, shared and exclusive data for example. System memory 125 is external to processors 111-114 whereas the processor memory arrays of core 0, namely L1(0), L2(0), L2 DIR(0) and L3 DIR(0), and their core 1 counterparts, are internal to processors 111-114.

FIG. 3 is an alternative block diagram representation of multi-processor data processing system 105. Service processor 165 operates under the control of HMC 175 in control computer system 170. Hypervisor 310, although shown as a separate block in FIG. 3, is control software or firmware that operates across all processors in system 105. Hypervisor 310 controls the partitioning of the processors in system 105 so that, for example, an operating system OS-A operates in one partition and an operating system OS-B operates in another partition. Hypervisor 310, under the direction of HMC 175 and service processor 165, may assign other operating systems, OS-N, or different instances of the OS-A and/or OS-B operating systems, to remaining unconfigured or spare processors such as processor 114 in FIG. 1. In this representation, the physical processors (CPUs), system memory and I/O circuitry conceptually combine in a common CPU-memory-I/O block 305 to indicate that the CPUs, memory and I/O are resources that hypervisor 310 may partition and configure.

An uncorrectable error in a processor memory array such as a cache memory in a conventional multi-processor data processing system may cause a checkstop that takes down an entire partition of processors. This causes downtime while the system or partition reboots and the system either “gards out” (i.e. takes off-line) or repairs the processor containing the error. Another term for “garding out” a processor from a current array of processors is deconfiguring the processor containing the error from the current configuration of processors. To avoid future errors from an error producing processor, garding out of that processor effectively marks the processor as bad so that the system does not use the processor in the future. In FIG. 1, the current configuration includes the processors in partitions 180 and 185, but does not include spare processor 114. Hypervisor 310 may partition processor 114 and include processor 114 in the current configuration at a later time. If the cores of processor 114 later join the current configuration of cores under hypervisor 310, then the processor cores of processor 114 are available for data processing activities.

Data processing system 105 of FIG. 1 provides a core checkstop capability that allows a single processor core to checkstop without taking down the entire system. Each of the cores in processors 111, 112 and 113 in the current configuration may generate a respective core checkstop, namely a local checkstop. Hypervisor 310 effectively couples to each of the cores of processors 111, 112 and 113 of the current configuration to monitor for a core checkstop from any of these cores. A core checkstop may occur when a processor memory array of a particular processor core contains an error. For example, an error in one of processor memory arrays L1(0), L2(0), L2 DIR(0) or L3(0) that relate to processor core C0 of processor 111 in FIG. 2 causes a core checkstop in processor core C0 of processor 111. When such a core checkstop occurs, hypervisor 310 moves the workload from that processor core C0 to a spare processor core such as one of the cores in processor 114 of FIG. 1. To achieve this workload transfer, system 105 employs saved checkpoints. Saved checkpoints are those checkpoints that a properly functioning processor core saves while it operates. The saved checkpoints include the contents of the processor core's registers and the states of the processor core's pipeline. In this manner, when a core checkstop occurs due to an error in a core, the system may transfer that core's workload and saved checkpoints to another processor core for handling. After completion of the workload transfer from the core exhibiting the error, system 105 gards out or deconfigures that core from the current configuration while the remaining cores of the system continue operation in run time without interruption of user programs. In other words, when hypervisor 310 encounters a core checkstop from core C0 of processor 111, hypervisor 310 removes this core 0 from the current configuration of processor cores available to handle data processing activities such as software application execution.

The disclosed multi-processor data processing system 105 can attempt to recover from an error in one of the processor memory arrays that associate with each particular core in the current configuration of processor cores. The current configuration of processor cores refers to those processor cores currently in a partition and available for data processing activities such as software application execution and operating system activities. Thus, the current configuration shown in FIG. 1 includes the processor cores of processors 111, 112 and 113, but does not include the spare processor cores of processor 114.

The processor memory arrays experiencing an error from which system 105 may attempt recovery using the disclosed methodology include memory arrays such as L1(0), L2(0), L2 DIR(0) or L3(0) of each processor core in the current configuration of processor cores. In one embodiment, each of processor memory arrays L1(0), L2(0), L2 DIR(0) and L3(0) includes error correcting code (ECC) bits, namely redundant bits, to enable error correction of information entries therein via bit steering. As a representative example, consider the case where system 105 attempts to recover from an error in the L2(0) cache array of processor 111. When system 105 detects an error in memory array L2(0) of processor core C0 of processor 111, this event causes processor core C0 of processor 110 to generate a core checkstop and reinitialize or reboot processor core C0. During the reboot of processor core C0 of processor 111, the remaining cores of system 105 continue operating in run time. After processor core C0 reinitializes, system 105 runs an extended array built-in self test (ABIST) on the failing component, namely the L2(0) cache memory array of processor 111 in this particular example. As shown in FIG. 1, processors 111, 112, 113 and 114 each include a respective ABIST engine 115-1, 115-2, 115-3 and 115-4 that performs extended ABIST. The ABIST engines interface with JTAG bus 167. In the present example, when processor core C0 of processor 111 initializes or reboots, service processor code (not shown) in service processor 170 activates ABIST engine 115-1 via the JTAG bus 167. The service processor code also checks the results of running the extended ABIST on processor core C0 of processor 111. If the ABIST operation determines that an error is a correctable error, such as an error correctable via bit steering of redundant bits, then the ABIST makes the correction or repair at run time. However, if ABIST can not find the error or finds that there are no spare bits useable for correction, then the ABIST deconfigures the L2(0) cache or an error-containing slice of the L2(0) cache. In other words, ABIST removes the offending error-containing L2(0) portion from the current configuration of processor cores available for data processing activity. The service processor code or firmware then employs a concurrent maintenance procedure to bring the processor core back on-line. The service processor code or firmware then reintegrates the processor core back into the running system, namely the current configuration of processor cores. When system 105 reintegrates the processor core that experienced the error back into the system, that processor core will exhibit either a repaired L2(0) memory array or an L2(0) memory array with a garded memory slice. System 105 performs these error handling operations without interruption of system work during run time of the remaining processor cores that do not exhibit the processor memory array error.

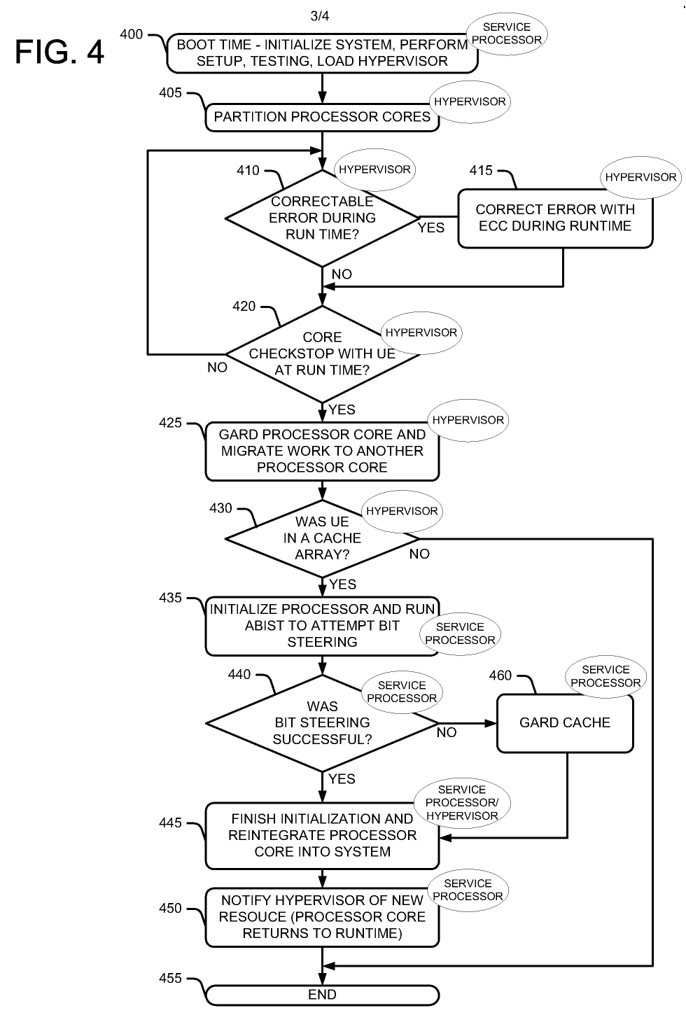

FIG. 4 is a flowchart that depicts process flow in one embodiment of the disclosed error handling methodology for a multi-processor data processing system. Before commencing run time operations in the FIG. 4 flowchart, service processor 165 conduct boot time activities, as per block 400. More specifically, service processor 165 initializes or boots system 105 under the direction of hardware management console (HMC) 175. Service processor 165 performs setup operations for the processors and other components of system 105. During this boot time or initialization time, service processor 165 initializes the physical components of system 105 and performs built-in self tests (BIST) on such components to assure that they all function properly. After setup and testing, service processor 165 loads into system memory 125 the hypervisor 310, namely a software layer that exists between the physical processors and the operating systems. Hypervisor 310 operates at run time and keeps track of the separation of partition resources, such as processors, memory and I/O devices. The hypervisor 310 also stores address translation information for memory 125. The hypervisor 310 also sets up and controls the partitioning of the processor cores of processors 111-114 to establish the current configuration of processor cores, all as per block 405. Application programs that execute under operating system OS-A and OS-B in of FIG. 3 must go through hypervisor 310 to obtain access to the physical CPUs (processors), memory and I/O that block 305 of FIG. 3 represents.

Returning to the flowchart of FIG. 4, when the “boot time” of block 400 completes, the processors of system 105 commence “run time” during which operating systems operate and applications execute on the processors. While executing applications, a correctable error or an uncorrectable error may occur in a processor core or associated memory arrays in the processors. In this particular example, a correctable error such as a single bit error occurs in cache memory array L1(0) of core C0 of processor 111, as per block 410. The cache memory L1(0) itself detects the correctable error and employs an error correcting code (ECC) to correct the error on the fly without exiting run time, as per block 415. If the error is not correctable at run time, then process flow continues from block 410 to block 420 as shown in FIG. 4.

In one embodiment, hypervisor 310 acts as a core error handler that monitors all cores of the current configuration of processors for uncorrectable errors. Uncorrectable errors are errors that are not correctable during the run time of the core experiencing the error. A multibit error is an example of an uncorrectable error. In this particular example, hypervisor 310 detects a core checkstop from core C1 of processor 111 during run time, as per block 420. For discussion purposes, an uncorrectable error in the cache memory array L2(1) causes this uncorrectable error, although uncorrectable errors may also occur in the other memory arrays of L1(1), L2 DIR(1) and L3 DIR(1). When the core C1 checkstop occurs, hypervisor 310 detects this local checkstop and prepares to migrate the workload of core C1 of processor 111 to another processor core, for example core C0 of processor 113 if that core is available, as per block 425. In more detail, the core checkstop from core C1 of processor 111 causes that core C1 to freeze its state. As stated above, a processor core saves checkpoints during the normal operation of the processor core. Thus, the state of this processor core is seamlessly transferable to another available processor core if the former processor core encounters an uncorrectable error and generates a checkstop. In the present example, hypervisor 310 then takes core C1 of processor 111 off-line. In other words, hypervisor 310 gards out the offending core C1 and removes this core C1 from the current configuration of system 105, as per block 425. While in this off-line state, core C1 of processor 111 can not propagate further errors. In actual practice, hypervisor 310 may detect the uncorrectable error and report the uncorrectable error to service processor 165. Hypervisor 310 may detect the local checkstop of core C1 of processor 111 and take action to gard out this core C1 and remove this core C1 from the current configuration of processors. In this situation, the hypervisor is the mechanism that actually migrates the workload that core C1 of processor 111 previously performed to another processor core such as core C0 of processor 113.

The hypervisor 310 determines if the uncorrectable error (UE) is in a processor memory array such as a cache memory of the processor core issuing the core checkstop, as per decision block 430. In other words, if core C1 of processor 111 checkstops, the decision block 430 determines if this core checkstop comes from memory arrays of the L1(1), L2(1), L2 DIR(1) and L3 DIR(1) of processor 111. If the uncorrectable error does come from one of these processor memory arrays, then service processor 165 initializes or reboots the offending processor core C1 of processor 111, as per block 435. Service processor 165 has low-level access via JTAG bus 165 to the core exhibiting the core checkstop, namely core C1 of processor 111 in this example, to enable service processor 165 to re-initialize that core. The service processor 165 runs array built-in self testing (ABIST) firmware to attempt correction of the error in the processor memory array via bit steering. Core C1 of processor 111 now runs in boot time while the remaining processor cores of system 105 continue processing applications during their run time. Service processor 165 performs a test to determine if the bit steering attempt to correct the error in the offending processor memory array succeeded, as per block 440. If bit steering succeeded in correcting the error that was uncorrectable during the offending core 1 run time, then service processor 165 finishes reinitialization of this processor core 1, as per block 445. In response to a command from service processor 165, the hypervisor 310 reintegrates core C1 of processor 111 into the current configuration when system 105 needs this core 1 for data processing activities. For example, the hypervisor 310 places core C1 of processor 111 into a partition with other processor cores in preparation for data processing activities. Next, the service processor 165 notifies the hypervisor 310 of the new resource, namely that core 1 of processor 111 is in a partition ready for use as a system resource at run time, as per block 450. This error handling process then ends at end block 455. In actual practice, the system 105 continues operating at run time with hypervisor 310 monitoring for local checkstops, as per block 410.

If bit steering is not successful in correcting, at boot time, the error that was previously uncorrectable at run time, then service processor 165 gards the offending memory array or the portion of the offending memory array that contains the error, as per block 460. In other words, in this example, the hypervisor may take the portion of memory array L2(1) containing the error off-line so that it can produce no more errors. Service processor 165 then finishes initialization of core 1 of processor 111, as per block 445. Core 1 of processor is then once again available at run time for handling data processing tasks. If in decision block 430 the hypervisor finds that the uncorrectable error did not originate from a processor memory array, then this processor core error handling process ends at block 455. Again, in actual practice, the hypervisor continues to look for local core checkstops, as per block 410.

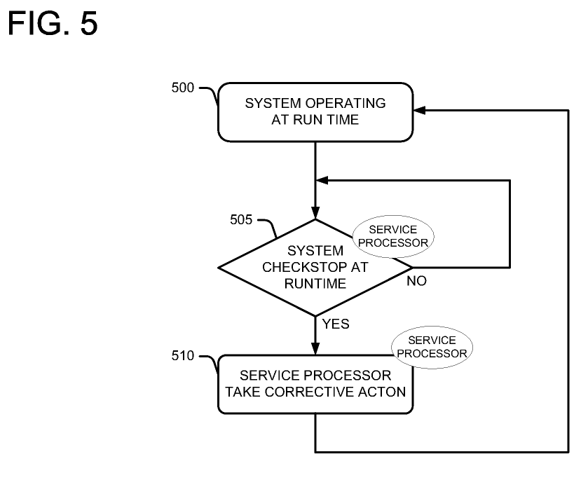

FIG. 5 is a flowchart that depicts process flow in the handling of system checkstops by data processing system 105. As described above, hypervisor 310 handles core checkstops. However, service processor 165 handles system checkstops. A system checkstop is a major system event that requires processors in the system to halt and reinitialize. An example of such a major system event that causes a system checkstop is an uncorrectable error (UE) in fabric 120 because such an event involves more than just a single core. System 105 operates at run time, as per block 500. Service processor 165 monitors for a system checkstop from processors 111-114. If service processor 165 does not receive a system checkstop, then service processor 165 continues monitoring for a system checkstop, as per decision block 505. However, if service processor 165 receives a system checkstop, then service processor 165 takes corrective action, as per block 510. For example, upon detection of a system checkstop, the service processor localizes the problem by reading error registers (not shown) in all processors of the system. The service processor then generates a system dump by collecting hardware scan ring data and some predefined contents of system memory. After this error data collection is complete, system 105 may automatically re-IPL (initial program load) if the user so configures service processor 165. In one embodiment, the service processor may optionally generate a field replaceable unit (FRU) callout so that a service technician can replace the defective part.

Modifications and alternative embodiments of this invention will be apparent to those skilled in the art in view of this description of the invention. Accordingly, this description teaches those skilled in the art the manner of carrying out the invention and is intended to be construed as illustrative only. The forms of the invention shown and described constitute the present embodiments. Persons skilled in the art may make various changes in the shape, size and arrangement of parts. For example, persons skilled in the art may substitute equivalent elements for the elements illustrated and described here. Moreover, persons skilled in the art after having the benefit of this description of the invention may use certain features of the invention independently of the use of other features, without departing from the scope of the invention.

What is claimed is:

1. A method of repairing a data processing system during run time of the system, the method comprising:
processing information during run time, by a particular processor core of the data processing system, to handle a workload assigned to the particular processor core, wherein the data processing system includes a plurality of processors that include multiple processor cores of which the particular processor core is one processor core;
receiving, by a core error handler, a core checkstop from the particular processor core, the core checkstop indicating an error that is uncorrectable at run time of the particular processor core;
transferring, by the core error handler in response to the core checkstop, the workload of the particular processor core to another processor core of the system and moving the particular processor core off-line;
initializing, by a service processor, the particular processor core if a processor memory array of the particular processor core exhibits an error that is not correctable at run time, thus initiating a boot time for the particular processor core;
attempting, by the service processor, to correct the error at boot time of the particular processor core; and
moving, by the service processor, the particular processor core back on-line if the attempting step is successful in correcting the error so that the particular processor core may again process information at run time.

2. The method of claim 1, wherein the processor cores of the system other than the particular processor core continue to operate at run time during the initializing and attempting steps.

3. The method of claim 1, wherein the attempting step comprises a bit steering operation.

4. The method of claim 1, wherein the attempting step comprises an array built-in self test (ABIST) operation.

5. The method of claim 1, further comprising determining, by the core error handler, if the error is from a processor memory array of the particular processor core.

6. The method of claim 5, wherein the processor memory array is one of an L1 cache array, an L2 cache array and an L3 cache array of the particular processor core.

7. The method of claim 5, wherein if the attempting step is unsuccessful the service processor deconfigures a portion of the processor memory array containing the error.

8. The method of claim 1, wherein the core error handler is a hypervisor.

9. The method of claim 8, further comprising receiving, by the service processor, a system checkstop from one of the plurality of multi-core processors.

10. The method of claim 9, further comprising reinitializing the data processing system, by the service processor, in response to the system checkstop.

11. A multi-processor data processing system comprising:
a plurality of processors, each processor including a plurality of processor cores;
a service processor, coupled to the plurality of processor cores, to handle system checkstops from the plurality of processors;
a core error handler, coupled to the plurality of processor cores, to handle core checkstops from the plurality of processor cores, wherein the core error handler:
receives a core checkstop from a particular processor core, the core checkstop indicating an error that is uncorrectable at run time of the particular processor core;
transfers the workload of the particular processor core to another processor core of the system and moves the particular processor core off-line in response to the core checkstop;
wherein the service processor:
initializes the particular processor core if a processor memory array of the particular processor core exhibits an error that is not correctable at run time, thus initiating a boot time for the particular processor core;
attempts to correct the error at boot time of the particular processor core; and
moves the particular processor core back on-line if the attempt to correct the error at boot time is successful so that the particular processor core may again process information at run time.

12. The multi-processor data processing system of claim 11, wherein the processor cores of the system other than the particular processor core continue to operate at run time while the service processor attempts to correct the error at boot time.

13. The multi-processor data processing system of claim 11, wherein the service processor performs a bit steering operation to attempt to correct the error at boot time of the particular processor core.

14. The multi-processor data processing system of claim 11, wherein the processor cores includes ABIST circuitry that tests the processor cores at boot time.

15. The multi-processor data processing system of claim 11, wherein the core error handler determines if the error is from a processor memory array of the particular processor core.

16. The multi-processor data processing system of claim 15, wherein the processor memory array is one of an L1 cache array, an L2 cache array and an L3 cache array of the particular processor.

17. The multi-processor data processing system of claim 15, wherein the service processor deconfigures a portion of the processor memory array containing the error if attempting to correct the error at boot time is unsuccessful.

18. The multi-processor data processing system of claim 11, wherein the core error handler comprises a hypervisor.

19. The multi-processor data processing system of claim 18, wherein the service processor receives a system checkstop from one of the plurality of multi-core processors.

20. The multi-processor data processing system of claim 19, wherein the service processor reinitializes the data processing system in response to a system checkstop.

21. An information handling system comprising:
a plurality of processors, each processor including a plurality of processor cores;
a system memory coupled to the plurality of processor cores;
non-volatile storage coupled to the plurality of processor cores;
a service processor, coupled to the plurality of processor cores, to handle system checkstops from the plurality of processors;
a core error handler, coupled to the plurality of processor cores, to handle core checkstops from the plurality of processor cores, wherein the core error handler:
receives a core checkstop from a particular processor core, the core checkstop indicating an error that is uncorrectable at run time of the particular processor core;
transfers the workload of the particular processor core to another processor core of the system and moves the particular processor core off-line in response to the core checkstop,
wherein the service processor:
initializes the particular processor core if a processor memory array of the particular processor core exhibits an error that is not correctable at run time, thus initiating a boot time for the particular processor core;
attempts to correct the error at boot time of the particular processor core; and
moves the particular processor core back on-line if the attempt to correct the error at boot time is successful so that the particular processor core may again process information at run time.

22. The information handling system of claim 21, wherein the processor cores of the system other than the particular processor core continue to operate at run time while the service processor attempts to correct the error at boot time.

23. The information handling system of claim 21, wherein the service processor performs a bit steering operation to attempt to correct the error at boot time of the particular processor core.

24. The information handling system of claim 21, wherein the processor cores includes ABIST circuitry that tests the processor cores at boot time.

25. The information handling system of claim 21, wherein the core error handler determines if the error is from a processor memory array of the particular processor core.

26. The information handling system of claim 25, wherein the processor memory array is one of an L1 cache array, an L2 cache array and an L3 cache array of the particular processor.

27. The information handling system of claim 25, wherein the service processor deconfigures a portion of the processor memory array containing the error if attempting to correct the error at boot time is unsuccessful.

28. The information handling system of claim 21, wherein the core error handler comprises a hypervisor.

29. The information handling system of claim 28, wherein the service processor receives a system checkstop from one of the plurality of multi-core processors.

30. The information handling system of claim 29, wherein the service processor reinitializes the data processing system in response to a system checkstop.
